(19) United States
(12) Patent Application Publication
(10) Pub. No.: US 2010/0065157 A1
(43) Pub. Date: Mar. 18, 2010

(54) COAT-FORMING CORROSION PREVENTATIVE WITH REDUCED CRACK FORMATION AND PROCESS FOR ITS ELECTROLESS APPLICATION

(75) Inventors: Michael Dornbusch, Ludenscheid (DE); Andrea Wiesmann, Muenster (DE)

Correspondence Address: Mary E. Golota;Cantor Colburn LLP, 201 W. Big Beaver Road, Suite 1101, Troy, MI, 48084, US

(73) Assignee: BASF COATINGS AG, Munster (DE)

(21) Appl. No.: 12/514,643

(22) PCT Filed: Sep. 19, 2007
(86) PCT No.: PCT/EP07/08136

§ 371 Date: May 13, 2009

(30) Foreign Application Priority Data
Nov. 13, 2006 (DE) 10 2006 053 292.9

(51) Int. Cl. C23C 22/00; C09D 5/08

(52) U.S. Cl. 148/243; 148/23

(57) ABSTRACT

The invention relates to an aqueous coating material for metallic substrates, comprising a water-dispersible and/or water-soluble polymer P with covalently bonded ligands A, which form chelates with the metal ions released during the corrosion of the substrate and/or with the substrate surface, and having crosslinking functional groups B, which with themselves, with further complementary functional groups B′ of the polymer P and/or with further functional groups B and/or B′ are able to form covalent bonds to crosslinkers V, and at least one surface-active substance OS at the surface of the substrate to be coated.

Processes and coating materials for the electroless corrosion-control coating of a variety of metal substrates are known. In comparison to anodic or cathodic electrodeposition (AED or CED, respectively), where the application of electrical voltages is a requirement, they offer the advantage, in particular, of a simpler and less expensive operation and of a shorter operating time. The electroless processes make it possible, in particular, to coat cavities in or edges on the target substrates more effectively than using processes requiring the application of electrical voltages.

In the case of electroless corrosion-control coating, also called ACC (autophoretic chemical coating) process, polymers are generally used, examples being emulsion polymers containing acrylates or styrene/butadiene, which are anionically stabilized. As compared with the aforementioned AED and CED processes, however, the ACC processes have the drawback that the deposited coats exhibit defects which render the substrate significantly more susceptible to corrosion. Consequently, coats of this kind deposited by means of ACC processes are generally treated by rinsing with aqueous coating materials containing chromium, in order to improve corrosion control at the defects. Recently, however, it has turned out that chromium coating materials have great problems in terms of environmental compatibility, and are to be classified as highly hazardous to health. The aim is therefore completely to replace chromium in corrosion-control coatings.

In the train of the development of chromium-free coating materials it has been found, furthermore, that ACC coating materials comprising salts of the lanthanide elements and of the d elements and also an organic, film-forming component likewise ensure very good corrosion control, comparable with that of the chromium coating materials. WO-A-01/86016 describes a corrosion preventative comprising a vanadium component and a further component which comprises at least one metal selected from the group consisting of zirconium, titanium, molybdenum, tungsten, manganese, and cerium. A drawback of corrosion preventatives of WO-A-01/86016 type is the tendency of the metal ions formed from the substrate to migrate through the deposited corrosion-control coat, since the polymers result in deficient film formation.

WO-A-99/29927 describes a chromium-free, aqueous corrosion preventative whose components comprise hexafluoro anions of titanium(IV) and/or zirconium(IV), vanadium ions, transition-metal ions, and phosphoric and/or phosphonic acid. Disadvantages associated with corrosion preventatives of the WO-A-99/29927 type is the tendency of the metal ions formed from the substrate to migrate through the deposited corrosion-control coat, since the polymers result in deficient film formation, and the use of environmentally critical substances, such as hydrofluoric acid or fluorides in particular.

WO-A-96/10461 describes an aqueous corrosion preventative whose components comprise anions with a central atom selected from the group consisting of titanium, zirconium, hafnium, and silicon, and at least 4 fluorine-atom ligands, and an organic polymer dispersion. A drawback of the invention according to WO-A-96/10461 is that deposition of the corrosion preventative on the substrate surface is accompanied by flocculation of the polymer-dispersion particles, which makes their surface contact area small. Moreover, the latex particles have the drawback of a relatively low migration rate in the context of diffusion into cavities or onto edges of three-dimensional substrates, in comparison to polymers whose distribution is molecularly disperse. Moreover, coats with a thickness of between 1 micrometer and 1 mm are formed, entailing a corresponding consumption of material per unit area of the substrate to be coated. Coats of such thicknesses have a pronounced tendency to form cracks in the course of drying, particularly at high temperatures. Further drawbacks include the tendency of the metal ions formed from the substrate to migrate through the deposited corrosion-control coat, and the use of environmentally critical substances, such as hydrofluoric acid or fluorides in particular.

DE-A-37 27 382 embraces chromium-free, aqueous dispersions of adducts of carboxylic acids and isocyanates with epoxides, which are suitable for autophoretic coating of metallic surfaces. In dispersed form such dispersions have a particle diameter of less than 300 nm, preferably between 100 and 250 nm, and after deposition on the metal surface can be crosslinked at temperatures between 60 and 200° C. Latex particles of this kind, too, have the drawback of having a relatively low migration rate in the context of diffusion into cavities or onto edges of three-dimensional substrates, in comparison to polymers whose distribution is molecularly disperse. Moreover, coats with a thickness of between 1 micrometer and 1 mm are formed, entailing a corresponding consumption of material per unit area of the substrate to be coated. Coats of such thicknesses have a pronounced tendency to form cracks in the course of drying, particularly at high temperatures. Further drawbacks include the tendency of the metal ions formed from the substrate to migrate through the deposited corrosion-control coat, and the use of environmentally critical substances, such as hydrofluoric acid or fluorides in particular.

DE-A-103 30 413 describes coating materials which are suitable for coating metallic surfaces and may comprise caprolactam-modified polyisocyanates based on polyethyleneimines. The coating compositions can be applied by deposition coating and, after drying, have thicknesses of between 1 and 300 micrometers. Coats produced in this way likewise require a high level of material and have a pronounced tendency to form cracks on drying, particularly at high temperatures.

### PROBLEM AND SOLUTION

In the light of the aforementioned prior art the problem addressed by the invention was that of finding a corrosion preventative which is largely unobjectionable from an environmental standpoint and which can be applied by a readily technically accomplishable operation to the substrate that is to be protected. Furthermore the corrosion preventative ought substantially to prevent the migration of the metal ions formed from the substrate and ought to be deposited effectively on edges and in cavities of the substrate. Moreover, the effect of extraneous metal ions ought to be kept very low, and effective corrosion control ought to be obtained with a comparatively low level of material employed. Furthermore, the conversion coating material ought to develop effective protection for as many different metal substrates as possible and ought to be substantially independent of the redox potential of the substrate to be coated. In particular, the tendency to form cracks in the corrosion-control coat in the course of drying and during the baking step ought to be suppressed, since the corrosion-control effect is significantly impaired by the channels through the coat that arise in the event of cracking.

In the light of the aforementioned problems, an aqueous coating material has been found which comprises a water-dispersible and/or water-soluble polymer P and a surface-active substance OS at the surface of the substrate to be coated, the polymer P having randomly distributed covalently bonded ligands A, which form chelates with the metal ions released during the corrosion of the substrate and/or with the substrate surface, and having randomly distributed crosslinking functional groups B, which with themselves, with further functional groups B′ of the polymer P and/or with further functional groups B and/or B′ are able to form covalent bonds to crosslinkers V.

Also found has been a process for the autophoretic application of an aqueous coating material for metallic substrates featuring effective corrosion control, comprising the aforementioned water-dispersible and/or water-soluble polymer P and also a substance OS which is surface-active at the surface of the substrate to be coated, the thickness of the coating after autophoretic application being between 5 and 900 nm.

In a further preferred embodiment of the process of the invention, prior to the deposition of the corrosion preventative of the invention, in a further upstream process step, the substrate is pretreated with a corrosion inhibitor K.

### DESCRIPTION OF THE INVENTION

### The Coating Material of the Invention

The water-dispersible and/or water-soluble polymers P of the coating material of the invention carry ligands A, which form chelates with the metal ions released during the corrosion of the substrate, and crosslinking functional groups B, which are able with themselves and/or with further functional groups C to form covalent bonds to crosslinkers V.

For the purposes of the invention, water-dispersible or water-soluble means that the polymers P in the aqueous phase form aggregates having an average particle diameter of <50 nm, preferably <35 nm, and more preferably <20 nanometers, or else are in molecularly disperse solution. Such aggregates differ critically in their average particle diameter from dispersion particles, as are described, for example, in DE-A-37 27 382 or WO-A-96/10461. Polymers P in molecularly disperse solution generally have molecular weights of <100 000, preferably <50 000, and more preferably <10 000 daltons.

The size of the aggregates composed of polymer P comes about, in conventional manner, through the introduction of hydrophilic groups HG on the polymer P. The number of hydrophilic groups HG on the polymer P depends on the solvation capacity and the steric accessibility of the groups HG and can be adjusted by the skilled worked likewise conventionally. Preferred hydrophilic groups HG on the polymer P are ionic groups, such as, in particular, sulfate, sulfonate, phosphate, phosphonate, ammonium and/or carboxylate groups, and also nonionic groups, such as, in particular, hydroxyl groups, primary, secondary and/or tertiary amine groups and/or amide groups, and/or oligoalkoxy or polyalkoxy substituents, such as, preferably, ethoxylated or propoxylated substituents, which may have been etherified with further groups. The hydrophilic groups HG may be identical with the ligands A and/or crosslinking groups B or B′ described below.

Polymers which can be used as the backbone of the polymers P are arbitrary per se, preference being given to polymers having molecular weights of 500 to 50 000 daltons and more preference to those having molecular weights of 700 to 20 000 daltons. Preferred backbone polymers used are polyolefins or poly(meth)acrylates, polyurethanes, polyalkyleneimines, polyvinylamines, polyalkyleneamines, polyethers, polyesters, and polyalcohols, which in particular are partially acetalized and/or partially esterified. The polymers P may be linear, branched and/or dendritic in construction. Especially preferred polymer backbones are polyalkyleneimines, polyvinylamines, polyalcohols, poly(meth)acrylates, and hyperbranched polymers, as are described, for example, in WO-A-01/46296.

The polymers P are preferably stable to hydrolysis in the acidic pH range, in particular at pH values <5, more preferably at pH values <3.

Suitable ligands A are all groups or compounds which are able to form chelates with the metal ions released during the corrosion of the substrate. Preference is given to monodentate and/or polydentate, potentially anionic ligands. Particularly preferred ligands are
unfunctionalized or functionalized ureas and/or thioureas, especially acylthioureas such as benzoylthiourea, for example;
unfunctionalized or functionalized amines and/or polyamines, such as EDTA in particular;
unfunctionalized or functionalized amides, especially carboxamides;
imines and imides;
oximes, preferably 1,2-dioximes such as functionalized diacetyldioxime;
organosulfur compounds, such as, in particular, unfunctionalized or functionalized thiols such as thioethanol, thiocarboxylic acids, thioaldehydes, thioketones, dithiocarbamates, sulfonamides, thioamides, and, with particular preference, sulfonates;
organophosphorus compounds, such as, in particular, phosphates, more preferably phosphoric esters of (meth)acrylates, and also phosphonates, more preferably vinylphosphonic acid and hydroxy-, amino- and amido-functionalized phosphonates;
unfunctionalized or functionalized organoboron compounds, such as boric esters in particular;
unfunctionalized or functionalized polyalcohols, such as, in particular, carbohydrates and their derivatives and also chitosans;
unfunctionalized or functionalized acids, such as, in particular, difunctional and/or oligofunctional acids, or unfunctionalized or functionalized (poly)carboxylic acids, such as, in particular, carboxylic acids, which may be attached ionically and/or coordinatively to metal centers, preferably (poly)methacrylates containing acid groups, or difunctional or oligofunctional acids;
unfunctionalized or functionalized carbenes;
acetylacetonates;
unfunctionalized or functionalized heterocycles, such as quinolines, pyridines, such as, in particular, imine-functionalized pyridines, pyrimidines, pyrroles, furans, thiophenes, imidazoles, benzimidazoles, preferably mercaptobenzimidazoles, benzothiazoles, oxazoles, thiazole, pyrazoles or else indoles;
unfunctionalized or functionalized acetylenes; and
phytic acid and its derivatives.

Suitable crosslinking functional groups B on the polymer P are those which with themselves and/or with complementary functional groups B′ are able to form covalent bonds. Preferably the covalent bonds are formed thermally and/or by exposure to radiation. With particular preference the covalent bonds are formed thermally. The crosslinking functional groups B and B′ result in the formation of an intermolecular network between the molecules of the polymer P.

Functional groups B and/or B′ which crosslink on exposure to radiation contain activable bonds, such as carbon-hydrogen, carbon-carbon, carbon-oxygen, carbon-nitrogen, carbon-phosphorus or carbon-silicon bonds, which may be single or double bonds. Carbon-carbon double bonds are particularly advantageous in this context. Especially suitable carbon-carbon double bonds as groups B are
with particular preference (meth)acrylate groups
ethyl acrylate groups
vinyl ether groups and vinyl ester groups
crotonate groups and cinnamate groups
allyl groups
dicyclopentadienyl groups
norbornyl groups and isoprenyl groups
isopropenyl groups or butenyl groups.

Thermally crosslinking functional groups B are able with themselves or, preferably, with complementary crosslinking functional groups B′ to form covalent bonds on exposure to thermal energy.

Especially suitable thermally crosslinking functional groups B and B′ are
with particular preference hydroxyl groups
mercapto groups and amino groups
aldehyde groups
azide groups
acid groups, especially carboxylic acid groups
acid anhydride groups, especially carboxylic anhydride groups
acid ester groups, especially carboxylic ester groups
ether groups
with particular preference carbamate groups
urea groups
epoxide groups
with particular preference isocyanate groups, which with very particular preference have been reacted with blocking agents which unblock at the baking temperatures of the coating materials of the invention and/or without unblocking are incorporated into the network that forms.

Particularly preferred combinations of thermally crosslinking groups B and complementary groups B′ are:
hydroxyl groups with isocyanate and/or carbamate groups,
amino groups with isocyanate and/or carbamate groups, and
carboxylic acid groups with epoxide groups.

Suitable crosslinkers V containing groups B and/or B′ which crosslink thermally and/or by exposure to radiation are, in principle, all crosslinkers known to the skilled worker. Preference is given to low molecular weight or oligomeric crosslinkers V, having a molecular weight of <20 000 daltons, more preferably <10 000 daltons. The backbone of the crosslinkers V that carries the crosslinking groups B and/or B′ may be linear, branched and/or hyperbranched in construction. Preference is given to branched and/or hyperbranched structures, particularly those as described in WO-A-01/46296.

The crosslinkers V are preferably stable to hydrolysis in the acidic pH range, in particular at pH values <5, more preferably at pH values <3. Particularly preferred crosslinkers V carry the above-described crosslinking groups B and/or B′ which react with the crosslinking groups of the polymer P to form covalent bonds. Especially preferred crosslinkers V are those having groups B and/or B′ which crosslink thermally and, if desired, additionally by exposure to radiation. In one further particularly preferred embodiment of the invention the crosslinkers V, as well as the crosslinking groups B and/or B′, carry ligands L, which may be identical with and/or different from the ligands L of the polymer P. Particularly suitable crosslinking functional groups B and B′ for the crosslinkers V are:
especially hydroxyl groups
especially aldehyde groups
azide groups
acid anhydride groups, especially carboxylic anhydride groups
carbamate groups
urea groups
especially isocyanate groups, which with very particular preference are reacted with blocking agents which unblock at the baking temperatures of the coating materials of the invention and/or without deblocking are incorporated into the network which forms
(meth)acrylate groups
vinyl groups
   or combinations thereof.

Especially preferred crosslinkers V are branched and/or hyperbranched polyisocyanates which are at least partly blocked and which additionally carry ligands L.

In one further embodiment of the invention the crosslinkers V carry groups B and/or B′ which are capable of forming covalent bonds with the ligands L of the polymer P.

The surface-active substance, OS, that is active at the surface of the substrate to be coated comprises at least one component KOS which reduces the surface tension of the coating material of the invention in the course of autophoretic deposition on the uncoated substrate surface and/or in the course of the subsequent drying step.

The component KOS can be chosen from the group of anionic, cationic, and nonionic surface-active substances. Preference is given to using amphiphilic substances, which may be of low molecular mass, oligomeric and/or polymeric. “Amphiphilic” means that the substances have a hydrophilic and a hydrophobic structural component. “Low molecular mass” means that the average molecular weights of the surface-active component KOS are up to 2000 daltons, more preferably up to 1000 daltons; “oligomeric” means that the surface-active component KOS contains about 2 to 30, preferably 3 to 15, preferably repeating structural units and has an average molecular weight of between about 200 and 4000 daltons, preferably between about 500 and 3000 daltons; and “polymeric” means that the surface-active component KOS contains more than 10 preferably repeating structural units and has an average molecular weight of more than 500 daltons, preferably of more than 1000 daltons. The surface-active components KOS may differ from the polymer P of the invention.

For the surface-active components KOS use is made preferably, as low molecular mass substances, of alkylcarboxylic acid and salts thereof, alpha,omega-dicarboxylic acids and salts thereof, alpha,omega-dialcohols, alpha,omega-diamines and diamides and their salts, alkylsulfonic acids and their salts, and alkylphosphoric acids and alkylphosphonic acids and their salts. Oligomeric and/or polymeric surface-active substances used are preferably polyalkylene glycols, polyvinyl lactams, such as polyvinylpyrrolidone and polyvinylcapro-lactam, for example, polyvinylimidazoles, polyvinyl alcohols, and polyvinyl acetate. Of very particular preference as surface-active component KOS are, as low molecular mass substances, adipic acid and/or 1,6-hexanediol and, as oligomeric and/or polymeric substances, poly(oligo)ethylene glycols and/or poly(oligo)propylene glycols. The fraction of the surface-active substance OS as a proportion of the coating material of the invention is preferably between 10⁻⁴% and 5% by weight, preferably between 10⁻²% and 2% by weight, based on the coating material, the component KOS being present in the surface-active substance OS preferably in fractions of 1% to 100% by weight, based on OS, more preferably in fractions of 2% to 100% by weight.

The continuous phase used for the coating material of the invention is water, preferably deionized and/or distilled water. In addition, in the continuous phase, there may be largely water-miscible solvents present in fractions of up to 30% by weight, preferably up to 25% by weight, based on the continuous phase. Preferred water-miscible solvents are ethanol, propanol, methyl ethyl ketone, N-ethylpyrrolidone. Particularly when using the coating materials of the invention in the repair of paint damage on substrates that have already been painted, the water-miscible solvents are used in fractions of 1% to 30% by weight, based on the continuous phase, preferably in fractions of 2% to 25% by weight.

A further preferred component used is at least one acid capable of oxidation, which is used such that the pH of the coating material of the invention is preferably between 1 and 5, more preferably between 2 and 4. Particularly preferred acids are selected from the group consisting of oxidizing mineral acids, such as, in particular, nitric acid, nitrous acid, sulfuric acid and/or sulfurous acid. To adjust the pH it is possible, where necessary, to use a buffer medium, such as, for example, salts of strong bases and weak acids, such as ammonium acetate in particular.

In one particularly preferred embodiment of the invention the coating material of the invention further comprises a salt having as its cationic constituent lanthanide-metal cations and/or d-metal cations.

Preferred lanthanide metal cations are lanthanum, cerium, praseodymium, neodymium, promethium, samarium, europium and/or dysprosium cations. Lanthanum, cerium, and praseodymium cations are especially preferred. The lanthanide-metal cations can be in monovalent, divalent and/or trivalent oxidation state, preference being given to the trivalent oxidation state.

Preferred d-metal cations are titanium, vanadium, manganese, yttrium, zirconium, niobium, molybdenum, tungsten, cobalt, ruthenium, rhodium, palladium, osmium and/or iridium cations. Barred from consideration as a d-element cation is the chromium cation in any oxidation state. Vanadium, manganese, tungsten, molybdenum and/or yttrium cations are especially preferred. The d-element cations can be present in monovalent to hexavalent oxidation state, preference being given to a trivalent to hexavalent oxidation state.

### The Process for Applying the Coating Material of the Invention

Before the coating material of the invention is applied, in one preferred embodiment of the invention the substrate is clean, in particular of oily and fatty residues, employing preferably detergents and/or alkaline cleaning materials. In a further preferred version of the invention the cleaning with detergents and/or alkaline cleaning materials is followed, and the application of the coating material of the invention preceded, by rinsing with water. In order to remove deposits and/or chemically modified films, especially oxidized films, from the surface of the substrate, in a further preferred embodiment of the invention the rinse step is preceded by mechanical cleaning of the surface, using abrasive media for example, and/or by chemical removal of the surface films, using deoxidizing cleaning materials for example.

The substrate thus pretreated is contacted with the coating material of the invention. This is preferably accomplished by immersing the substrate in or drawing it through a bath comprising the coating material of the invention. The residence times of the substrate in the coating material of the invention amount to preferably 1 second to 15 minutes, more preferably 10 seconds to 10 minutes, and very preferably 30 seconds to 8 minutes. The temperature of the bath comprising the coating material of the invention is preferably between 20 and 90° C., more preferably between 25 and 80° C., and very preferably between 30 and 70° C.

The thickness of the coat produced with the coating material of the invention after autophoretic application is preferably between 5 and 900 nm, more preferably between 10 and 800 nm, which, relative to the corrosion-control effect, allows a significant saving in terms of material employed.

Treatment of the substrate with the coating material of the invention is followed preferably by drying of the system comprising substrate and coating material at temperatures between about 30 and 200° C., in particular between 100 and 180° C.; the drying apparatus can be regarded as largely uncritical to the advantageous effect of the coating material of the invention. Where the crosslinking groups B and/or B′ are at least partly radiation-curing, the coat of the coating material of the invention is irradiated, preferably in a manner known to the skilled worker by actinic radiation and/or by electron beams, this irradiation taking place, where appropriate, in addition to the thermal treatment.

The coating material of the invention can, surprisingly, be employed on a wide spectrum of substrates and is largely independent of the substrate's redox potential.

Preferred substrate materials are zinc, iron, magnesium, and aluminum, and also alloys thereof, said alloys preferably containing at least 20% by weight of the aforementioned metals. The substrates are preferably formed as metal sheets, as are employed, for example, in the automotive, construction, and mechanical engineering industries. The sheets coated with the coating material of the invention are employed in connection in particular with profiled sheets and with the coil-coating of sheets.

In a further embodiment of the invention the coating materials of the invention are used for sealing cut edges of the above-described sheets, especially for sealing the cut edges of sheets which have already been coated.

In a further embodiment of the invention the above-described substrates, before the coating material of the invention is deposited, are coated with a further corrosion inhibitor which can likewise be deposited electrolessly. Preference is given to corrosion inhibitors having inorganic constituents which exhibit effective adhesion both to the coat of the coating material of the invention and to the uncoated substrate. Inorganic corrosion inhibitors of this kind are described in, for example, EP-A-1 217 094, EP-A-0 534 120, U.S. Pat. No. 5,221,371, and WO-A-01/86016.

In one particularly preferred embodiment of the invention the application of the coating material of the invention is preceded, in a separate step, by application of an aqueous corrosion preventative K having a pH of between 1 and 5 and comprising at least one compound AA having as its cation a lanthanide metal and/or a d-element metal bar chromium and/or as its anion a d-element metallate, bar chromium-containing metallates, and also BB at least one acid capable of oxidation, with the exception of phosphorus and/or chromium acids.

The salt forming component AA has as its cationic constituent lanthanide-metal cations and/or d-metal cations. Preferred lanthanide-metal cations are lanthanum, cerium, praseodymium, neodymium, promethium, samarium, europium and/or dysprosium cations.

Lanthanum, cerium, and praseodymium cations are especially preferred. The lanthanide-metal cations can be in monovalent, divalent and/or trivalent oxidation state, the trivalent oxidation state being preferred. Preferred d-metal cations are titanium, vanadium, manganese, yttrium, zirconium, niobium, molybdenum, tungsten, cobalt, ruthenium, rhodium, palladium, osmium and/or iridium cations. Barred from consideration as a d-element cation is the chromium cation in any oxidation state. Vanadium, manganese, tungsten, molybdenum and/or yttrium cations are especially preferred. The d-element cations can be in a monovalent to hexavalent oxidation state, preference being given to a trivalent to hexavalent oxidation state.

The salts of the aforementioned cations of component AA are preferably of very good solubility in water. Particular preference is given to [cation]ₙ[anion]ₘ salts (with n and m each >=1) having a solubility product SP, i.e., [cation]ⁿ*[anion]^{m}, >10⁻⁸*mol^{(n+m)}/l^{(n+m)}, with very particular preference salts having a solubility product SP>10⁻⁶*mol^{(n+m)}/l^{(n+m)}. In one especially preferred embodiment of the invention the concentration of the salt or salts (A) in the corrosion preventative is 10⁻¹ to 10⁻⁴ mol/l, in particular 5*10⁻¹ to 10⁻³ mol/l.

The anions which together with the d-element cations form the salts AA are preferably selected such that the aforementioned conditions for the solubility product SP are met. Preference is given to using anions of oxidizing acids of the elements of transition groups VI, VII and VIII of the Periodic Table of the Elements and also to anions of oxidizing acids of the elements of main groups V and VI of the Periodic Table of the Elements, with the exception of anions of oxidizing acids of phosphorus and chromium, particular preference being given to the use of nitrates, nitrites, sulfites and/or sulfates. Further preferred anions are halides, such as chlorides and bromides in particular.

In a further preferred embodiment of the invention the d-element cations can also be present in the form of complexes with monodentate and/or polydentate, potentially anionic ligands. Preferred ligands are unfunctionalized or functionalized terpyridines and/or pyridines, such as, in particular, imine-functionalized pyridines, unfunctionalized or functionalized pyrimidines, unfunctionalized or functionalized benzimidazoles, unfunctionalized or functionalized quinolines, unfunctionalized or functionalized imidazoles, unfunctionalized or functionalized thiazoles, unfunctionalized or functionalized oxazoles, unfunctionalized or functionalized pyrazoles, unfunctionalized or functionalized ureas and/or unsubstituted or substituted thioureas, unfunctionalized or functionalized amines and/or polyamines, such as EDTA in particular, imines, such as imine-functionalized pyridines in particular, organosulfur compounds, such as, in particular unfunctionalized or functionalized thiols, thiocarboxylic acids, thioaldehydes, thioketones, dithiocarbamates, sulfonamides, thioamides, and, with particular preference, sulfonates, unfunctionalized or functionalized organoboron compounds, such as boric esters in particular, unfunctionalized or functionalized polyalcohols, such as, in particular, carbohydrates and their derivatives and also chitosans, unfunctionalized or functionalized acids, such as difunctional and/or oligofunctional acids in particular, unfunctionalized or functionalized carbenes, acetylacetonates, functionalized heterocycles, such as quinolines, pyridines, such as, in particular, imine-functionalized pyridines, pyrimidines, pyrrols, furans, thiophenes, imidazoles, benzimidazoles, preferably mercaptobenzimidazoles, benzothiazoles, oxazoles, thiazole, pyrazoles or else indols, unfunctionalized or functionalized acetylenes, unfunctionalized or functionalized carboxylic acids, such as, in particular, carboxylic acids which can be attached ionically and/or coordinatively to metal centers, and also phytic acid and its derivatives.

Especially preferred ligands are phytic acids, derivatives thereof, and sulfonates, which may have been functionalized.

In a further embodiment of the invention the salts AA contain as their anions d-element metallates which together with the d-element cations or else on their own are able to form the salt AA. Preferred d elements for the metallates are vanadium, manganese, zirconium, niobium, molybdenum and/or tungsten. Vanadium, manganese, tungsten and/or molybdenum are especially preferred. Barred from consideration as a d-element metallate are chromates in any oxidation states. Particularly preferred d-element metallates are oxo anions, such as tungstates, permanganates, vanadates and/or molybdates in particular.

Where the d-element metallates form the salt AA on their own, in other words without lanthanide-metal cations and/or d-metal cations, the abovementioned comments regarding the preferred solubility product SP of such salts apply here as well. Preferred cations of such salts are ammonium ions, phosphonium ions and/or sulfonium ions, with or without substitution by organic radicals; alkali metal cations, such as lithium, sodium and/or potassium in particular; and alkaline earth metal cations, such as magnesium and/or calcium in particular. Particularly preferred ions are the ammonium ions, unsubstituted or substituted by organic radicals, and the alkali metal cations, which ensure a particularly high solubility product SP on the part of the salt AA.

As component BB of the corrosion preventative K use is made of at least one acid which is capable of oxidation, it being used such that the pH of the corrosion preventative is between 1 and 5, preferably between 2 and 4. Preferred acids BB are selected from the group consisting of oxidizing mineral acids, such as, in particular, nitric acid, nitrous acid, sulfuric acid and/or sulfurous acid.

In order to set the pH it is possible where necessary to employ a buffer medium, such as, for example, salts of strong bases and weak acids, such as ammonium acetate in particular.

The continuous phase used for the coating material of the invention is water, preferably deionized and/or distilled water.

In one preferred embodiment of the invention, prior to application of the corrosion preventive K, the substrate is cleaned, especially of oily and fatty residues, employing preferably detergents and/or alkaline cleaning materials. In another preferred version of the invention the cleaning with detergents and/or alkaline cleaning products is followed, and the application of the corrosion preventative K preceded, by a rinse with water. In a further preferred embodiment of the invention, for the purpose of removing deposits and/or chemically modified films, especially oxidized films, from the surface of the substrate, the rinse step is preceded by mechanical cleaning of the surface, using abrasive media for example, and/or by chemical removal of the surface films, using deoxidizing cleaning materials, for example.

The substrate thus pretreated is contacted with the corrosion preventative K. This is preferably accomplished by immersing the substrate in or drawing it through a bath comprising the corrosion preventative K. The residence times of the substrate in the corrosion preventative K amount to preferably 1 second to 10 minutes, preferably 10 seconds to 8 minutes, and more preferably 30 seconds to 6 minutes. The temperature of the bath comprising the corrosion preventative K is preferably between 25 and 90° C., more preferably between 30 and 80° C., and very preferably between 35 and 70° C.

After the substrate has been treated with the corrosion preventative of the invention it is preferred to carry out drying of the system comprising substrate and corrosion preventative, by means of blow drying or by means of drying at temperatures between about 30 and 200° C.; the drying temperature and also the type of drying or drying apparatus can be regarded as being largely uncritical to the advantageous effect of the corrosion preventative K.

In the second step of the preferred process the substrates coated with the corrosion preventative K are coated with the coating material of the invention. This is accomplished preferably by immersing or drawing the coated substrate in or through a bath comprising the coating material of the invention. The residence times of the substrate in the coating material of the invention amount to preferably 1 second to 15 minutes, more preferably 10 seconds to 10 minutes, and very preferably 30 seconds to 8 minutes. The temperature of bath comprising the coating material of the invention is preferably between 20 and 90° C., more preferably between 25 and 80° C., and very preferably between 30 and 70° C.

The thickness of the coat produced with the coating material of the invention after autophoretic application is preferably between 5 and 900 nm, more preferably between 10 and 800 nm, which relative to the corrosion-control effect allows a significant saving in terms of material employed.

After the substrate has been treated with the coating material of the invention it is preferred to carry out drying of the system comprising the substrate and the coats of the corrosion preventative K and also the coating material of the invention, at temperatures between 30 and 200° C., in particular between 100 and 180° C.; the drying apparatus can be regarded as being largely uncritical to the advantageous effect of the coating material of the invention. Where the crosslinking groups B and/or B′ are at least partly radiation-curing, irradiation of the coat of the coating material of the invention, preferably in a manner known to the skilled person, using actinic radiation and/or electron beams, is carried out, where appropriate in addition to the thermal treatment.

The examples given below are intended to provide further illustration of the invention.

### EXAMPLES

### Example 1a

### Preparation of the First Tank with the Corrosion Preventative K1

In one liter of water 1.77 g (0.01 mol) of ammonium molybdate tetrahydrate are dissolved and also 0.1 g of Disperbyk 184 as surface-active substance OS. The solution is adjusted using ammonia to a pH=2.5. Counter-buffering with nitric acid solution is used if desired in order to set the aforementioned pH. In comparative example 1a′, the abovementioned formula was used without the surface-active substance Disperbyk 184.

### Example 1b

### Preparation of the First Tank with the Corrosion Preventative K2

In one liter of water 5.5 g (0.01 mol) of ammonium cerium nitrate, 3.8 g (0.001 mol) of yttrium nitrate hexahydrate and 3.3 of phytic acid (40% strength in water) are dissolved; then 1.77 g (0.01 mol) of ammonium molybdate tetrahydrate are dissolved in the same solution, and also 0.1 g of Disperbyk 184 as surface-active substance OS. The solution is adjusted using ammonia to a pH=2.5. Counter-buffering with nitric acid solution is used if desired in order to set the aforementioned pH. In comparative example 1b', the abovementioned formula was used without the surface-active substance Disperbyk 184.

### Example 2a

### Synthesis of the Polymer Component P1 for the Coating Material of the Invention

5 g (6.25*10⁻³ mol) of a polyethyleneimine having an average molecular weight Mw=800 g/mol (Lupasol FG from BASF AG, ratio of primary to secondary to tertiary amino groups (p-s-t): 1:0.9:0.5) in 100 g of ethanol are introduced as an initial charge under a nitrogen atmosphere and at 75° C. a solution of 10.7 g (0.066 mol) of benzoyl isothiocyanate in 86 g of ethanol is added over the course of 45 minutes. Stirring is continued at this temperature for 4 h and the product is employed without further purification.

### Example 2b

### Synthesis of the Polymer Component P2 for the Coating Material of the Invention

5 g (6.25*10⁻³ mol) of a polyethyleneimine having an average molecular weight Mw=2000 g/mol (Lupasol PR 8515 from BASF AG, ratio of primary to secondary to tertiary amino groups (p-s-t): 1:0.9:0.6) in 100 g of ethanol are introduced as an initial charge under a nitrogen atmosphere and at 75° C. a solution of 10.3 g (0.066 mol) of benzoyl isothiocyanate in 86 g of ethanol is added over the course of 45 minutes. Stirring is continued at this temperature for 4 h and the product is employed without further purification.

### Example 2c

### Synthesis of the Crosslinker V1 for the Coating Material of the Invention

12 g (0.07 mol) of diethyl (hydroxymethyl)phosphonate are reacted together with 50 g (5.81% NCO content) of an 81% strength butyl acetate solution of a branched polyisocyanate with 50% of dimethylpyrazole blocking (Bayhydur VP LS 2319 from Bayer AG) at 80° C. for four hours. After the solvent has been removed, the residue is admixed at 30° C. with 150 ml of a 10M NaOH and the mixture is treated at this temperature for four hours. This gives a white solid which is used without further purification.

### Example 2d

### Synthesis of the Crosslinker V2 for the Coating Material of the Invention

3.1 g (0.008 mol) of cerium(III) chloride heptahydrate in 50 ml of water are introduced as an initial charge. A solution is prepared from 4.1 g (0.025 mol) of 4-hydroxycinnamic acid and 1 g (0.025 mol) of sodium hydroxide in 50 ml of water and adjusted using hydrochloric acid to a pH=7.9. This solution is slowly added to the cerium solution, so that the pH of the cerium solution does not rise above 6. The precipitate is washed with ethanol and water.

1.7 g (0.003 mol) of this cerium complex is reacted at 40° C. for five hours with 9.1 g (2.5% NCO content) of a branched polyisocyanate with 75% dimethylpyrazole blocking (Bayhydur VP LS 2319 from Bayer AG) in 80.1 g of ethyl acetate and 0.7 g of an OH-functional dipropylene-triamine (Jeffcat-ZR 50 from Huntsmann). The product is employed without further purification.

### Example 3a

### Preparation of the Second Tank with the Coating Material of the Invention

In one liter of water in each case 3 g of the polymer components P1 and P2 from Examples 2a and 2b and also 3 g of Albritect CP30 (copolymer of acrylic acid and vinylphosphonic acid with an approximately 30% phosphonic acid fraction, Rhodia) and 6 g of the crosslinker V1 from Example 2c and 0.1 g of Disperbyk 184 (from Byk-Chemie) as surface-active substance OS are dissolved. The solution is adjusted using nitric acid to a pH=2.5. Counter-buffering with aqueous ammonia solution is used if desired in order to set the aforementioned pH.

### Example 3b

### Preparation of the Second Tank with the Coating Material of the Invention

In one liter of water in each case 3 g of the polymer component P1 from Example 2a, and 2 g of the crosslinker V2 from Example 2d and 0.1 g of Disperbyk 184 (from Byk-Chemie) as surface-active substance OS are dissolved. The solution is adjusted using nitric acid to a pH=2.5. Counter-buffering with aqueous ammonia solution is used if desired in order to set the aforementioned pH.

### Comparative Examples 3a′ and 3b′

### Preparation of the Second Tank with a Coating Material According to Examples 3a and 3b without Surface-Active Substance OS

### Example 4a

### Coating of the Substrate with the Corrosion Preventative K and the Coating Material of the Invention

The substrate (sheet of galvanized steel) is cleaned in a cleaning solution (Ridoline C72 from Henkel) at 55° C. for 5 minutes and thereafter rinsed with distilled water.

Subsequently the sheet rinsed with distilled water is immediately immersed in the first tank of the corrosion preventative K1 from Example 1a at 45° C. for 4 minutes. Thereafter the coated sheet is rinsed with distilled water and blown dry with nitrogen.

Directly after that the sheets are immersed in the second tank of the corrosion preventative of the invention from Example 3b at 35° C. for 5 minutes. A coat ranging from non-visible to opalescent is formed, in the λ/4 region of visible light. Thereafter the coated sheet is rinsed with distilled water and blown dry with nitrogen.

The sheet is subsequently dried at 80° C. for 20 minutes.

### Example 4b

### Coating of the Substrate with the Corrosion Preventative K and the Coating Material of the Invention

The substrate (sheet of galvanized steel) is cleaned in a cleaning solution (Ridoline C72 from Henkel) at 55° C. for 5 minutes and thereafter rinsed with distilled water.

Subsequently the sheet rinsed with distilled water is immediately immersed in the first tank of the corrosion preventative K2 from Example 1b at 45° C. for 4 minutes. Thereafter the coated sheet is rinsed with distilled water and blown dry with nitrogen.

Directly after that the sheets are immersed in the second tank of the corrosion preventative of the invention from Example 3a at 35° C. for 5 minutes. A coat ranging from non-visible to opalescent is formed, in the λ/4 region of visible light. Thereafter the coated sheet is rinsed with distilled water and blown dry with nitrogen.

The sheet is subsequently dried at 80° C. for 20 minutes.

### Example 4a′

### Coating of the Substrate with the Corrosion Preventative K and the Coating Material (without Surface-Active Substance OS)

The substrate (sheet of galvanized steel) is cleaned in a cleaning solution (Ridoline C72 from Henkel) at 55° C. for 5 minutes and thereafter rinsed with distilled water.

Subsequently the sheet rinsed with distilled water is immediately immersed in the first tank of the corrosion preventative K1 from Example 1a′ (without surface-active substance OS) at 45° C. for 4 minutes. Thereafter the coated sheet is rinsed with distilled water and blown dry with nitrogen.

Directly after that the sheets are immersed in the second tank of the corrosion preventative of the invention from Example 3b′ (without surface-active substance OS) at 35° C. for 5 minutes. A coat ranging from non-visible to opalescent is formed, in the λ/4 region of visible light. Thereafter the coated sheet is rinsed with distilled water and blown dry with nitrogen.

The sheet is subsequently dried at 80° C. for 20 minutes.

### Example 4b′

### Coating of the Substrate with the Corrosion Preventative K and the Coating Material (without Surface-Active Substance OS)

The substrate (sheet of galvanized steel) is cleaned in a cleaning solution (Ridoline C72 from Henkel) at 55° C. for 5 minutes and thereafter rinsed with distilled water.

Subsequently the sheet rinsed with distilled water is immediately immersed in the first tank of the corrosion preventative K2 from Example 1b′ (without surface-active substance OS) at 45° C. for 4 minutes. Thereafter the coated sheet is rinsed with distilled water and blown dry with nitrogen.

Directly after that the sheets are immersed in the second tank of the corrosion preventative of the invention from Example 3a′ (without surface-active substance OS) at 35° C. for 5 minutes. A coat ranging from non-visible to opalescent is formed, in the λ/4 region of visible light. Thereafter the coated sheet is rinsed with distilled water and blown dry with nitrogen.

The sheet is subsequently dried at 80° C. for 20 minutes.

### Example 5

### Accelerated Corrosion Test with Harrison Solution on the Substrates Coated as Per Example 4

A Harrison solution (5 g of NaCl+35 g of (NH₄)₂SO₄) in 1000 ml of fully demineralized water is used. Substrates which can be utilized here are steel, galvanized steel or zinc alloys. Adhered to the surface of the samples (6*6 cm) coated with the coat elucidated above is a plastic cylinder with a diameter of 48 mm and a height of 6 cm, using an adhesive: Scrintec 600 transparent silicone adhesive, RTV 1k oxime system (from Ralicks, 46459 Rees). 70 ml of Harrison solution are placed in this cylinder. These samples are used to conduct an electrochemical impedance measurement (EIS) in a 2-electrode arrangement from 1 MHz to 100 mHz, with an amplitude of 1 mV and open potential, using a platinum mesh as the counter-electrode.

The samples thus prepared are weathered for a total of 20 cycles in a temperature range from 25° C. to 73° C. in such a way that the maximum and minimum temperature are each passed through within one hour. After this cycling, the cylinder, which is now dry, is again filled with 30 ml of Harrison solution, and after a residence time of 10 minutes this solution is used for the determination of any ions that have been dissolved in the course of weathering, by means of ICP-OES (inductively coupled plasma-optical emission spectrometry). Subsequently, again, 70 ml of Harrison solution are introduced into the cylinder and a further EIS measurement is carried out. After the EIS measurement a further weathering by the accelerated test is carried out, and then, again, an ICP-OES sample is taken and a further EIS measurement is performed.

The measurement is verified by means of a duplicate determination.

### Evaluation of the Corrosion Test:

### a) ICP-OES Data of the Immersion Solution

The ICP-OES data are standardized for the area of the samples. These data produce a linear plot. Because of the linearity of the corrosion kinetics it is possible to compare the different coatings through the slopes of the graph. The ICP-OES data reproduce the dissolution of the substrate per unit area and unit time and are therefore a direct measure of the corrosion rate which is possible for any particular coating.

### b) EIS Measurements

The EIS measurements are interpreted in respect of the formation of pores or in respect of other time constants in the spectrum. In this case it is possible not only to view the coat but also to characterize the coating material more effectively in terms of its properties.

### Evaluation of Corrosion Test:

TABLE 1
Results of the corrosion test

| | ICP-OES data |
|---|---|
| Substrate | (10⁻⁴ * mol/l * h * cm²) |
| Galvanized steel panel | 17.7 |
| Granodine 958 54 (phosphating from Henkel) | |
| Galvanized steel panel | 2.1 |
| coated as per Example 4a′ without OS | |
| Galvanized steel panel | 1.6 |
| coated in accordance with Example 4a with OS | |
| Galvanized steel panel | 1.1 |
| coated according to Example 4b′ without OS | |
| Galvanized steel panel | 0.8 |
| coated in accordance with Example 4b with OS | |

The results of the corrosion tests clearly show the improvement in corrosion control through the coating material of the invention as compared with a commercially customary corrosion-control composition (Granodine) and also as compared with a corrosion-control agent of the invention not containing surface-active substance OS.

1. An aqueous coating material for a metallic substrates, the coating material comprising
a water-dispersible and/or water-soluble polymer P comprising
a) one or more covalently bonded ligands A, the ligands A being capable of forming chelates with the metal ions released during the corrosion of the substrate and/or with a surface of the substrate, and
b) crosslinking functional groups B, the crosslinking functional groups B being capable of forming covalent bonds to one or more crosslinkers V,
one or more crosslinkers V, and
and at least one surface-active substance OS at the surface of the substrate to be coated.

2. The aqueous coating material of claim 1, comprising the surface-active substance OS in fractions of between 10⁻⁴% to 5% by weight, based on the coating material.

3. The aqueous coating material of claim 1, wherein the surface-active substance OS comprises at least one component KOS selected from the group of polyalkylene glycols, polyvinyllactams, polyvinylimidazoles, polyvinyl alcohols, polyvinyl acetate, alkylcarboxylic acids and their salts, alpha,omega-dicarboxylic acids and their salts, alpha,omega-dialcohols, alpha,omega-diamines and diamides and their salts, alkylsulfonic acids and their salts, alkylphosphoric acids and alkylphosphonic acids and their salts.

4. The aqueous coating material of claim 1, wherein the crosslinkers V comprise covalently bonded ligands A.

5. The aqueous coating material of claim 1, wherein the ligands A are selected from the group consisting of ureas, amines, amides, imines, imides, pyridines, organosulfur compounds, organophosphorus compounds, organoboron compounds, oximes, acetylacetonates, polyalcohols, acids, phytic acids, acetylenes, carbenes, and mixtures thereof.

6. The aqueous coating material of claim 1, wherein the polymer P and the crosslinker V comprise crosslinking groups B and/or B′ which are crosslinkable thermally and/or by means of radiation.

7. The aqueous coating material of claim 1, further comprising a salt which as a cationic constituent contains lanthanide metal cations and/or d-metal cations, with the exception of chromium cations.

8. A process for the autophoretic application of an aqueous coating material to a metallic substrate, comprising depositing the aqueous coating material of claim 1 on the substrate, wherein the thickness of the coating after autophoretic application is between 5 and 900 nm.

9. A process for the corrosion-control treatment of a metallic substrates, which comprises immersing the substrate in a bath of the coating material of claim 1 for a time of 1 second to 15 minutes and at a temperature between 20 and 90° C.

10. A two-stage process for the corrosion-control treatment of a metallic substrates, which comprises
(I) in a first stage immersing the substrate in a bath of an aqueous corrosion preventative K, which results in conversion at the substrate surface, and
(II) in a second stage immersing the substrate treated as per stage (I) in a bath of the coating material of claim 1.

11. The process of claim 10, wherein the aqueous corrosion preventative K comprises
at least one compound having as its cation a lanthanide metal and/or a d-element metal bar chromium and/or as its anion a d-element metallate, with the exception of metallates containing chromium, and
at least one acid capable of oxidation, with the exception of phosphorus and/or chromium acids.

12. The process of claim 8, wherein following the deposition of the coating material the substrate is aftertreated thermally at temperatures between 50 and 200° C. and/or by irradiation.

13. The process of claim 8, wherein the substrate contains at least 20% by weight of a metal selected from the group consisting of Fe, Al and/or Zn.

14. The aqueous coating material of claim 1 wherein the crosslinking functional groups B are able to form covalent bonds to crosslinkers V with themselves, with further complementary functional groups B′ of the polymer P and/or with further functional groups B and/or B′.
